(19) United States
(12) Patent Application Publication
(10) Pub. No.: US 2024/0310507 A1
(43) Pub. Date: Sep. 19, 2024

(54) DISPLACEMENT MEASUREMENT USING MILLIMETER-WAVE METAMATERIAL TARGETS

(71) Applicant: Infineon Technologies AG, Neubiberg (DE)

(72) Inventors: Dirk HAMMERSCHMIDT, Finkenstein (AT); Christof MICHENTHALER, Feistritz an der Gail (AT)

(21) Appl. No.: 18/435,515

(22) Filed: Feb. 7, 2024

Related U.S. Application Data
(60) Provisional application No. 63/490,570, filed on Mar. 16, 2023.

(51) Int. Cl. G01S 13/75; G01D 5/48

(52) U.S. Cl. CPC G01S 13/751; G01D 5/48; G01D 2205/10; G01D 2205/20; G01D 2205/90

(57) ABSTRACT

A sensor system includes at least one transmitter; a receiver circuit; and a metamaterial layer having a relative position that is configured to vary relative to the transmitter. The metamaterial layer includes an array of elementary structures arranged within a coordinate system of the metamaterial layer. The array of elementary structures includes a first metamaterial characteristic that changes along a first coordinate variation of the coordinate system and a second metamaterial characteristic, different from the first metamaterial characteristic, that changes along a second coordinate variation of the coordinate system. The at least one transmitter is configured to transmit an electromagnetic transmit wave toward the metamaterial layer. The metamaterial layer is configured to convert the electromagnetic transmit wave into an electromagnetic receive wave based on the relative position. The receiver circuit is configured to receive the electromagnetic receive wave and determine the relative position based on the electromagnetic receive wave.

### CROSS REFERENCE TO RELATED APPLICATION

This patent application claims priority to U.S. Provisional Patent Application No. 63/490,570, filed on Mar. 16, 2023, and entitled “DISPLACEMENT MEASUREMENT USING MILLIMETER-WAVE METAMATERIAL TARGETS.” The disclosure of the prior application is considered part of and is incorporated by reference into this patent application.

### BACKGROUND

Vehicles feature numerous safety, body, and powertrain applications that rely on speed sensing, position sensing, and/or angle sensing. For example, in a vehicle's Electronic Stability Program (EPS), magnetic angle sensors and linear Hall sensors can be used to measure steering angle and steering torque. Modern powertrain systems can rely on magnetic speed sensors for camshaft, crankshaft, and transmission applications, along with automotive pressure sensors, to achieve required CO₂ targets and smart powertrain solutions.

### SUMMARY

A sensor system includes at least one transmitter; a receiver circuit; and a metamaterial layer having a relative position that is configured to vary relative to at least one of the at least one transmitter or the receiver circuit, wherein the metamaterial layer comprises an array of elementary structures arranged within a coordinate system of the metamaterial layer, wherein the array of elementary structures comprises a first metamaterial characteristic that changes along a first coordinate variation of the coordinate system and a second metamaterial characteristic that changes along a second coordinate variation of the coordinate system, and wherein the first metamaterial characteristic is different from the second metamaterial characteristic. The at least one transmitter is configured to transmit a first electromagnetic transmit wave toward the metamaterial layer. The metamaterial layer is configured to convert the first electromagnetic transmit wave into a first electromagnetic receive wave based on the relative position. The receiver circuit is configured to receive the first electromagnetic receive wave and determine the relative position based on the first electromagnetic receive wave.

### BRIEF DESCRIPTION OF THE DRAWINGS

Implementations are described herein making reference to the appended drawings.

FIG. 1A illustrates example elementary structures according to one or more implementations.

FIG. 1B illustrates different types of capacitively-coupled elementary structures according to one or more implementations.

FIG. 1C illustrates different types of inductively-coupled elementary structures according to one or more implementations.

FIG. 1D illustrates some example anisotropic metamaterial elementary structures according to one or more implementations.

FIG. 2 illustrates an example segment of a two-dimensional metamaterial array according to one or more implementations.

FIG. 3A illustrates a position sensor system according to one or more implementations.

FIG. 3B illustrates a position sensor system according to one or more implementations.

FIG. 4A illustrates a side view of a position sensor system according to one or more implementations.

FIG. 4B illustrates a perspective view of the position sensor system illustrated in FIG. 4A.

FIG. 5 illustrates an example transceiver circuit of a transceiver according to one or more implementations.

### DETAILED DESCRIPTION

In the following, details are set forth to provide a more thorough explanation of example implementations. However, it will be apparent to those skilled in the art that these implementations may be practiced without these specific details. In other instances, well-known structures and devices are shown in block diagram form or in a schematic view rather than in detail in order to avoid obscuring the implementations. In addition, features of the different implementations described hereinafter may be combined with each other, unless specifically noted otherwise.

Further, equivalent or like elements or elements with equivalent or like functionality are denoted in the following description with equivalent or like reference numerals. As the same or functionally equivalent elements are given the same reference numbers in the figures, a repeated description for elements provided with the same reference numbers may be omitted. Hence, descriptions provided for elements having the same or like reference numbers are mutually exchangeable.

Each of the x-axis, y-axis, and z-axis is substantially perpendicular to the other two axes. In other words, the x-axis is substantially perpendicular to the y-axis and the z-axis, the y-axis is substantially perpendicular to the x-axis and the z-axis, and the z-axis is substantially perpendicular to the x-axis and the y-axis. In some cases, a single reference number is shown to refer to a surface, or fewer than all instances of a part may be labeled with all surfaces of that part. All instances of the part may include associated surfaces of that part despite not every surface being labeled.

The orientations of the various elements in the figures are shown as examples, and the illustrated examples may be rotated relative to the depicted orientations. The descriptions provided herein, and the claims that follow, pertain to any structures that have the described relationships between various features, regardless of whether the structures are in the particular orientation of the drawings, or are rotated relative to such orientation. Similarly, spatially relative terms, such as “top,” “bottom,” “below,” “beneath,” “lower,” “above,” “upper,” “middle,” “left,” and “right,” are used herein for ease of description to describe one element's relationship to one or more other elements as illustrated in the figures. The spatially relative terms are intended to encompass different orientations of the element, structure, and/or assembly in use or operation in addition to the orientations depicted in the figures. A structure and/or assembly may be otherwise oriented (rotated 90 degrees or at other orientations), and the spatially relative descriptors used herein may be interpreted accordingly. Furthermore, the cross-sectional views in the figures only show features within the planes of the cross-sections, and do not show materials behind the planes of the cross-sections, unless indicated otherwise, in order to simplify the drawings.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

As used herein, the terms “substantially” and “approximately” mean “within reasonable tolerances of manufacturing and measurement.” For example, the terms “substantially” and “approximately” may be used herein to account for small manufacturing tolerances or other factors (e.g., within 5%) that are deemed acceptable in the industry without departing from the aspects of the implementations described herein. For example, a resistor with an approximate resistance value may practically have a resistance within 5% of the approximate resistance value. As another example, an approximate signal value may practically have a signal value within 5% of the approximate signal value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

Magnetic sensors may be used for speed sensing, position sensing, and/or angle sensing in various applications. However, a disadvantage of using magnetic sensors for speed sensing, position sensing, and/or angle sensing is that they are sensitive to magnetic disturbances. Magnetic disturbance fields are prevalent in vehicles such that magnetic measurements often have to endure harsh environments. This is especially problematic in hybrid and electric vehicles, where many wires and current rails carrying high currents can be located near a magnetic sensor system. Thus, magnetic disturbance fields generated by these high currents may influence the accuracy of magnetic measurements obtained by a magnetic sensor for speed sensing, position sensing, and/or angle sensing.

Some implementations disclosed herein are directed to a millimeter wave (mm-wave) sensor and mm-wave systems that include a mm-wave transmitter, a mm-wave receiver, and/or a mm-wave transceiver that are insensitive to magnetic disturbance fields. The mm-wave sensor or mm-wave system may be used for speed sensing, position sensing, and/or angle sensing. In some implementations, position sensing may include rotational position sensing. In some implementations, position sensing may include linear position sensing. In some implementations, position sensing may include measuring a displacement in two different directions using a mm-wave sensor and a two-dimensional (2D) structured metamaterial array.

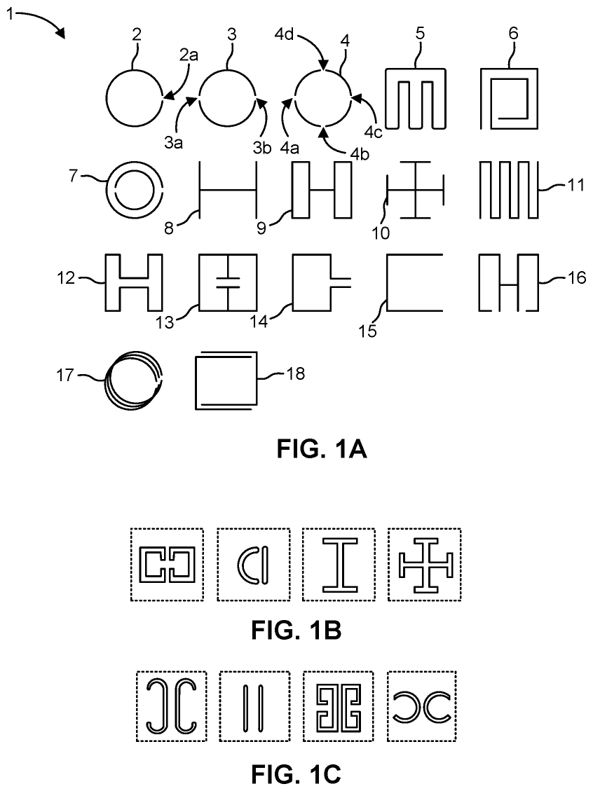

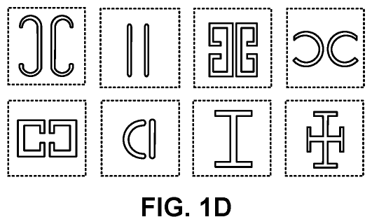

FIG. 1A illustrates example elementary structures according to one or more implementations. The elementary structures 1 include a split ring resonator 2 having one capacitor coupling 2a, a split ring resonator 3 having two capacitor couplings 3a and 3b, a split ring resonator 4 having four capacitor couplings 4a-4d, an antenna structure 5, an antenna coil 6, a nested split ring resonator 7, an antenna structure 8, an antenna structure 9, an antenna structure 10, a transmission line structure 11, an antenna structure 12, a coupled split ring resonator 13, a split ring resonator 14, a partial ring or coupling structure 15, a coupled split ring resonator 16, a stacked split ring resonator structure 17, and a split ring resonator 18. In some implementations, the elementary structures may be sensitive to mm-waves.

Mm-waves are radio waves designated in the band of radio frequencies in the electromagnetic spectrum from 30 to 300 gigahertz (GHz) and may also be used as radar waves. Thus, a mm-wave sensor, system, transmitter, receiver, or transceiver described herein may also be regarded as a radar sensor, system, transmitter, receiver, or transceiver, and a mm-wave may be regarded to as a radar signal. However, some implementations may also be applied in applications different from radar, such as radio frequency (RF) transmitters, receivers, or transceivers of RF devices. In fact, any RF circuitry may take advantage of the concepts described herein. A mm-wave sensor or mm-wave system may be configured, for example, as an angle sensor, a rotary position sensor, a linear position sensor, a speed sensor, a motion sensor, and/or a torque sensor.

A metamaterial is a material engineered to have a property that is not found in naturally occurring materials. The metamaterial is made from assemblies of multiple structural elements, also referred to as elementary structures, fashioned from composite materials such as metals or plastics. The structural elements may be arranged in repeating or periodic patterns, at scales that are smaller than the wavelengths of a phenomenon that the structural elements influence. In other words, metamaterials attain desired effects by incorporating structural elements of sub-wavelength sizes (e.g., features which are actually smaller than the wavelength of the electromagnetic waves that the structural elements affect).

As a result, metamaterials derive their properties not necessarily from the properties of the base materials, but from their designed structural elements. The precise shape, geometry, size, orientation, and arrangement of the structural elements gives the metamaterials their smart properties capable of manipulating electromagnetic waves (e.g., by blocking, reflecting, absorbing, enhancing, or bending waves) to achieve benefits. Thus, a metamaterial is defined as an artificial composite that gains its electrical properties from its exactingly-designed structural elements and the arrangement of the structural elements relative to each other, rather than directly from materials of which the metamaterial is composed.

A metamaterial may be a subset of a larger group of heterogeneous structures composed of a base solid material and structural elements of a different material. The distinction of metamaterials is that they have special, sometimes anomalous, properties over a limited frequency band. For example, mm-wave metamaterials may exhibit special properties over a millimeter band of spectrum between 30 GHz and 300 GHz, as noted above.

In the context of the described implementations, a metamaterial is a 2D or three-dimensional (3D) array of elementary structures, which are coupled to each other. “Elementary structures,” as used herein, may refer to discrete structures, element structures, or discrete element structures. In some cases, the elementary structures may be referred to simply as “structures.” Elementary structures themselves may be composed of one or more conductive elements. When composed of two or more conductive elements, the conductive elements of an elementary structure may be mutually coupled to each other by, for example, a capacitive coupling, an inductive coupling, or a galvanic coupling. Additionally, the conductive elements of adjacent elementary structures may be mutually coupled to each other by, for example, a capacitive coupling, an inductive coupling, or a galvanic coupling.

The overall array of elementary structures provides macroscopic properties, which can be configured by the elementary structures used and their coupling paths. Metamaterials are configured for different kind of waves like electromagnetic waves (e.g., optical, infrared (IR), and mm-waves) and mechanical waves (e.g., ultrasonic). The scales of the elementary structures and their grid pitch scale with the wavelength of a target frequency range (e.g., target frequency band).

Elementary structures in mm-wave metamaterials may include resonator elements, antenna elements, filter elements, waveguide elements, transmission line elements, or a combination thereof. An elementary structure size may range up to several wavelengths but is typically below one wavelength of a target frequency range. Elementary structures may include parts that generate magnetic fields (e.g., conductor rings) and other parts that create electrical fields (e.g., gaps between conductors). Furthermore, elementary structure may also have elements that have electromagnetic wave properties, such as a short transmission line segment.

In general, elementary structures may electrically represent resistive-inductive-capacitive (RLC) networks. In a frequency range in which the elementary structures will be used, a characteristic of their resistive, inductive, and capacitive parameters is distributed over the geometry of the metamaterial. Since filters, resonators, transmission lines, and antennas can be differently-parametrized representatives of identical structures, it is often not unambiguously possible to assign a structure to a single group. Thus, it is to be understood that a structure described as a resonator can also be seen as antenna or a filter, depending on its use or implementation details. Furthermore, the behavior of a structure may also change with the frequency where it is operated, and a structure that behaves as a transmission line for one frequency may also expose a filter characteristic or create a resonance at another frequency of operation. Finally, the choice of the material impacts the behavior, which means that a choice of a better conductor will emphasize a resonant behavior, while a less conductive material will increase damping and make a filter characteristic dominant.

The transmission line structure 11 may be a damping structure or delay structure. It may be used in an alternating configuration with resonators in order to establish an attenuated or phase-shifted coupling between the elementary structures instead of coupling directly. Coupling to the resonators can be capacitive or galvanic. The transmission line structure 11 may also extend onto a second layer, for example, with an identical structure creating a transmission line (e.g., two parallel wires).

The partial ring or coupling structure 15 may be referred to as a partial ring structure in the context of it being half of the split ring resonator 18. In this context, the partial ring structure 15 may be coupled to a second layer to form a resonator.

Furthermore, the elementary structures can be three-dimensional as well, such as spiral coils and nested split ring resonators that are oriented into all three Cartesian coordinate directions. Furthermore, three-dimensional structures can be generated by layering two-dimensional elementary structures in a stacked arrangement. For example, two elementary structures may be layered over one another in a vertical dimension so that they overlap with each other. In this way, a vertical capacitive coupling may be achieved between the two elementary structures and may be adjusted by varying an amount of overlap in a horizontal dimension.

The stacked split ring resonator structure 17 may have three split ring resonators stacked on top of each other. In some implementations, the stacked split ring resonator structure 17 may be formed by using three metallization layers stacked on top of each other.

The split ring resonator 18 may be made of two half-ring structures 15 that overlap, such that a vertical capacitive coupling exists between the two half-ring structures. By varying the amount of overlap, the loop size can be made larger (e.g., by decreasing the amount of overlap) or smaller (e.g., by increasing the amount of overlap), which in turn results in a lower vertical capacitive coupling or a higher vertical capacitive coupling, respectively.

In order to achieve a quasi-homogeneous macroscopic behavior, the elementary structures may be arranged in a 2D metamaterial array that may have dimensions that are larger than a wavelength of the target frequency range and include a plurality of elementary structures in each direction of the 2D metamaterial array.

As indicated above, FIG. 1A is provided as an example. Other examples may differ from what is described with regard to FIG. 1A.

FIG. 1B illustrates different types of capacitively-coupled elementary structures according to one or more implementations. Each of the elementary structures shown in FIG. 1B contains conductive elements (e.g., structures) that are mutually coupled via a capacitive coupling, either within the elementary structure itself or to a conductive element of a neighboring elementary structure. Each type of elementary structure may be repeated in an array of elementary structures (e.g., in a 2D metamaterial array).

As indicated above, FIG. 1B is provided as an example. Other examples may differ from what is described with regard to FIG. 1B.

FIG. 1C illustrates different types of inductively-coupled elementary structures according to one or more implementations. Each of the elementary structures shown in FIG. 1C contains conductive elements that are mutually coupled via an inductive coupling, either within the elementary structure itself or to a conductive element of a neighboring elementary structure. Each type of elementary structure may be repeated in an array of elementary structures (e.g., in a 2D metamaterial array).

As indicated above, FIG. 1C is provided as an example. Other examples may differ from what is described with regard to FIG. 1C.

FIG. 1D illustrates some example anisotropic metamaterial elementary structures according to one or more implementations. Each of the elementary structures shown in FIG. 1D has a characteristic resonant behavior when the structure interacts with incident electromagnetic waves of a certain polarization. Due to the anisotropy of the elementary structures, this resonant behavior is strongly dependent on the polarization of the electromagnetic field with which the elementary structures interact. For example, each of the elementary structures shown in FIG. 1D may have a sensitivity axis that defines a polarization sensitivity of the elementary structure. In some implementations, an elementary structure may be sensitive to a mm-wave that has an electric field that is aligned parallel to the sensitivity axis of the elementary structure and may be insensitive to a mm-wave that has an electric field that is aligned perpendicular to the sensitivity axis of the elementary structure. For example, an elementary structure may exhibit a characteristic resonant behavior when the mm-wave has an electric field that is aligned parallel to its sensitivity axis with a certain frequency. In contrast, the elementary structure may not show the characteristic resonant behavior when the mm-wave has an electric field that is aligned perpendicular to the sensitivity axis of the elementary structure and/or when the mm-wave has a frequency outside of a certain frequency or frequency band. Each type of elementary structure may be repeated in an array of elementary structures (e.g., in a 2D metamaterial array). Therefore, a 2D metamaterial array with anisotropic metamaterial elementary structures may be sensitive to a specific polarization of a mm-wave (e.g., to a specific polarization of an electric field of the mm-wave) and a target frequency or target frequency band, and may be substantially insensitive to other polarizations and/or substantially insensitive to frequencies outside of the target frequency or the frequency band.

As indicated above, FIG. 1D is provided as an example. Other examples may differ from what is described with regard to FIG. 1D.

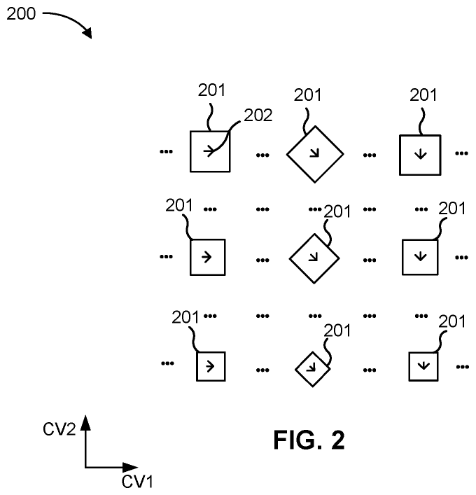

FIG. 2 illustrates an example segment of a 2D metamaterial array 200 according to one or more implementations. The 2D metamaterial array 200 may be a mm-wave metamaterial array that includes multiple elementary structures 201 arranged along both a first coordinate variation CV1 and a second coordinate variation CV2 of a coordinate system. In some implementations, the coordinate system may be a Cartesian coordinate system, the first coordinate variation CV1 may be a first axial direction of the Cartesian coordinate system (e.g., an x-axial direction), and the second coordinate variation CV2 may be a second axial direction of the Cartesian coordinate system (e.g., a y-axial direction) that is different from the first axial direction. For example, the elementary structures 201 of the 2D metamaterial array 200 may be arranged in the Cartesian coordinate system when utilized in a linear position measurement system in which a relative position of an object changes in a single linear direction or in two or more linear directions. In some implementations, the coordinate system may be a polar coordinate system, the first coordinate variation CV1 may be a radial dimension of the polar coordinate system, and the second coordinate variation CV2 may be an angular dimension of the polar coordinate system. For example, the elementary structures 201 of the 2D metamaterial array 200 may be arranged in the polar coordinate system when utilized in a rotational position measurement system or an angular position measurement system in which a relative position of an object changes based on a rotation about a rotational axis.

The elementary structures 201 may have a first metamaterial characteristic that changes along the first coordinate variation CV1 of the coordinate system and a second metamaterial characteristic that changes along the second coordinate variation CV2 of the coordinate system, where the first metamaterial characteristic is different from the second metamaterial characteristic.

In some implementations, the first metamaterial characteristic may be a radial orientation of the elementary structures 201 that changes incrementally along the first coordinate variation CV1. For example, in FIG. 2, the elementary structures 201 are shown as being rotated clockwise along the first coordinate variation CV1. The elementary structures 201 in a same column of the 2D metamaterial array 200 may have a same radial orientation, whereas the elementary structures 201 in different columns may have different radial orientations. Accordingly, each elementary structure 201 may have a unique radial orientation along the first coordinate variation CV1.

Thus, a first mm-wave property of the elementary structures 201 that affects a manner in which the elementary structures 201 interact with a mm-wave may incrementally change along the first coordinate variation CV1. When an elementary structure 201 interacts with an initial mm-wave, the elementary structure 201 may cause the initial mm-wave to be converted, for example, by reflection and/or absorption, into a converted mm-wave that has a first measurable property that corresponds to the first metamaterial characteristic of the elementary structure 201. By way of example, the converted mm-wave may have an amplitude or a frequency that that corresponds to the first metamaterial characteristic of the elementary structure 201. In other words, the converted mm-wave may undergo a change in amplitude and/or frequency, relative to an initial mm-wave, that corresponds to the first metamaterial characteristic of the elementary structure 201. Thus, differently oriented elementary structures may produce converted mm-waves having different values of the first measurable property.

In some implementations, the first metamaterial characteristic may be a polarization sensitivity of the elementary structures 201 that rotates incrementally along the first coordinate variation CV1. The elementary structures 201 in a same column of the 2D metamaterial array 200 may have a same polarization sensitivity, whereas the elementary structures 201 in different columns may have different polarization sensitivities. Accordingly, each elementary structure 201 may have a unique polarization sensitivity along the first coordinate variation CV1.

The elementary structures 201 may be any structure that is sensitive to a particular polarization, including the elementary structures shown in FIG. 1D. Each of the elementary structures 201 may have a sensitivity axis 202 (e.g., represented by an arrow) that corresponds to the polarization sensitivity. Each of the elementary structures 201 may be sensitive to mm-waves that have a wave component (e.g., an electric field component) that is aligned parallel to the sensitivity axis 202 and may be insensitive to mm-waves that do not have the wave component (e.g., the electric field component) that is aligned parallel with the sensitivity axis 202 (e.g., when the wave component is perpendicular to the sensitivity axis). As a result, the amplitude of the converted mm-wave may depend on the polarization sensitivity of the elementary structures 201 that perform a wave conversion. For example, the amplitude of the converted mm-wave may be at a maximum value when a polarization of the initial mm-wave is parallel to the sensitivity axis 202 of the elementary structures 201, and the amplitude of the converted mm-wave may be at a minimum value (e.g., zero) when the polarization of the initial mm-wave is perpendicular to the sensitivity axis 202 of the elementary structures 201. Thus, different polarization sensitivities may result in different amplitude shifts. Thus, the converted mm-wave may have a different amplitude, depending on a point of incidence of the initial mm-wave on the 2D metamaterial array 200.

In some implementations, the second metamaterial characteristic may be a geometry of the elementary structures 201 that is scaled incrementally along the second coordinate variation CV2. The elementary structures 201 in a same row of the 2D metamaterial array 200 may have a same geometry, whereas the elementary structures 201 in different rows may have different geometries. For example, a size of the elementary structures 201 may incrementally increase or decrease along the second coordinate variation CV2.

Thus, a second mm-wave property of the elementary structures 201 that affects a manner in which the elementary structures 201 interact with a mm-wave may incrementally change along the second coordinate variation CV2. When an elementary structure 201 interacts with an initial mm-wave, the elementary structure 201 may cause the initial mm-wave to be converted, for example, by reflection and/or absorption, into a converted mm-wave that has a second measurable property that corresponds to the second metamaterial characteristic of the elementary structure 201. By way of example, the converted mm-wave may have an amplitude or a frequency that corresponds to the second metamaterial characteristic of the elementary structure 201. In some implementations, a change in size of the elementary structures 201 along the second coordinate variation CV2 causes a resonance frequency of the 2D metamaterial array 200 to change along the second coordinate variation CV2. Different resonance frequencies may result in different frequency shifts, amplitude shifts, or phase shifts. Thus, the converted mm-wave may have a different frequency, amplitude, and/or phase, depending on a point of incidence of the initial mm-wave on the 2D metamaterial array 200.

In some implementations, a shift in the resonance frequency of the 2D metamaterial array 200 may result in a shift in amplitude or phase of a received wave. For example, a variation in resonance frequency of the 2D metamaterial array 200 can influence the received wave that can be detected in amplitude and phase or in real and imaginary parts of the received wave. Analyzing a shift of a resonance frequency may also be characterized over the frequency with a frequency sweep of a transmitted wave, but may require a more complex evaluation circuitry.

Accordingly, the first metamaterial characteristic affects a first mm-wave property of the 2D metamaterial array 200 and the second metamaterial characteristic affects a second mm-wave property of the 2D metamaterial array 200, with the first mm-wave property being different from the second mm-wave property. In some implementations, each elementary structure 201 has a unique coordinate within the coordinate system and has a unique combination of the first metamaterial characteristic and the second metamaterial characteristic. As a result, the elementary structures 201 have a coordinate-dependent characteristic that varies along the first coordinate variation of the coordinate system and varies along the second coordinate variation of the coordinate system. In some implementations, the coordinate-dependent characteristic is a coordinate-dependent coupling that varies along the first coordinate variation of the coordinate system and varies along the second coordinate variation of the coordinate system, and each coordinate of the 2D metamaterial array 200 has a unique coordinate-dependent coupling. The coordinate-dependent coupling includes at least one of capacitive near-field coupling, inductive near-field coupling, waveguide coupling, or far-field coupling. For example, the unique coordinate-dependent coupling may correspond to a case in which polarized mm-waves are used.

As indicated above, FIG. 2 is provided as an example. Other examples may differ from what is described with regard to FIG. 2.

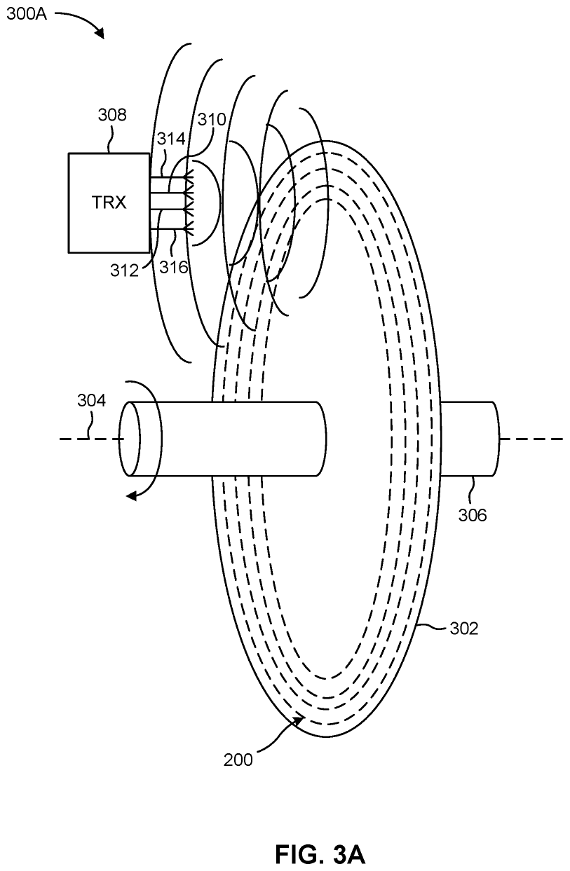

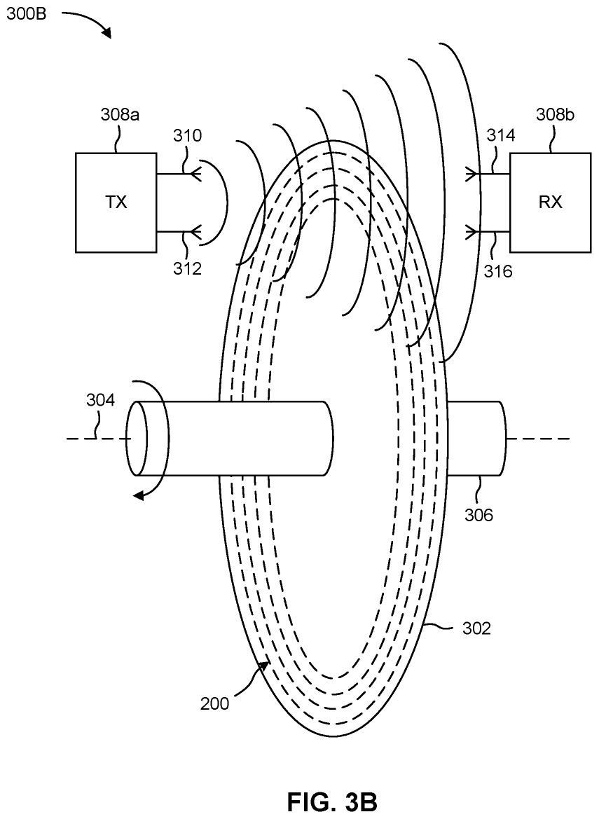

FIG. 3A illustrates a position sensor system 300A according to one or more implementations. For example, the position sensor system 300A may be a rotational position sensor system configured to measure a rotational position or a rotation angle. The position sensor system 300A may include a rotatable target object 302 configured to rotate about a rotational axis 304 (e.g., an axis of rotation). The rotatable target object 302 may be a disc or a wheel coupled to a shaft 306 that extends along the rotational axis 304. As the shaft 306 rotates, so does the rotatable target object 302. The rotatable target object 302 may represent a mechanical target for one or more mm-wave beams.

The position sensor system 300A further includes the 2D metamaterial array 200 coupled to the rotatable target object 302 as a metamaterial layer. The 2D metamaterial array 200 may form a closed loop around the rotational axis 304. Thus, the coordinate system of the 2D metamaterial array 200 in this example is the polar coordinate system. The 2D metamaterial array 200 is fixed to the rotatable target object 302 such that the 2D metamaterial array 200 co-rotates with the rotatable target object 302 as the rotatable target object 302 rotates.

The position sensor system 300A further includes a transceiver (TRX) 308 configured to transmit and receive electromagnetic waves (e.g., mm-waves). In particular, the transceiver 308 may be configured as a rotational position sensor that includes at least one transmitter antenna (e.g., transmitter antennas 310 and 312), at least one receiver antenna (e.g., receiver antennas 314 and 316), a transmitter circuit coupled to the at least one transmitter antenna, and a receiver circuit coupled to the at least one receiver antenna. The receiver circuit may include processing circuitry configured to process received signals for determining a rotational position.

The transmitter antennas 310 and 312 may be configured to transmit electromagnetic waves (e.g., mm-wave beams) as electromagnetic transmit waves at the 2D metamaterial array 200. The transceiver 308 may be rotationally fixed as the 2D metamaterial array 200 rotates about the rotational axis 304. However, in some implementations, the transceiver 308 may be coupled to the rotatable target object 302 and the 2D metamaterial array 200 may be coupled to a rotationally-fixed structure. In either case, the 2D metamaterial array 200 has a relative position that is configured to vary relative to the transceiver 308. The position sensor system 300A is configured to measure the relative position, regardless of which configuration is implemented.

In some implementations, the transmitter antenna 310 may be configured to transmit an electromagnetic transmit wave having a circular polarization and the transmitter antenna 312 may not be present or may be disabled. Each receiver antenna 314 and 316 may be configured to receive a partially-reflected electromagnetic receive wave from the 2D metamaterial array 200 based on the electromagnetic transmit wave and a rotational position of the 2D metamaterial array 200. In other words, the 2D metamaterial array 200 is configured to convert the electromagnetic transmit wave incident thereon into a corresponding electromagnetic receive wave via partial reflection. In a case in which the first metamaterial characteristic or the second metamaterial characteristic of the 2D metamaterial array 200 is a polarization sensitivity, the electromagnetic transmit wave will be reflected or converted differently based on the individual polarization sensitivities of the elementary structures 201 at which the electromagnetic transmit wave makes contact. Thus, an amplitude of the electromagnetic receive wave may change based on a rotational position of the 2D metamaterial array 200.

One or both of receiver antennas 314 and 316 may be configured to receive the electromagnetic receive wave from the 2D metamaterial array 200 and provide signals corresponding to the electromagnetic receive wave to a receiver circuit of the transceiver 308 for measurement. For example, the receiver circuit may be configured to measure an amplitude and/or a frequency of the electromagnetic receive wave as measured values.

In some implementations, the receiver circuit may be configured to generate a first measurement based on the electromagnetic receive wave, where the first measurement has a first dependency on the first metamaterial characteristic relative to the relative position. The receiver circuit may be further configured to generate a second measurement based on the electromagnetic receive wave, where the second measurement has a second dependency on the second metamaterial characteristic relative to the relative position. The receiver circuit may be further configured to determine the relative position based on the first measurement and the second measurement.

In some implementations, the receiver circuit may be configured to generate a first measured value of the electromagnetic receive wave, generate a second measured value of the electromagnetic receive wave, apply a first function using the first measured value and the second measured value to obtain the first measurement, apply a second function using the first measured value and the second measured value to obtain the second measurement, and determine a relative position (e.g., a rotational position) of the 2D metamaterial array 200 relative to the transceiver 308 based on the first measurement and the second measurement. The second function is different from the first function such that the first measurement is different from the second measurement.

The first function may have a first defined correlation with a variation of the first metamaterial characteristic relative to the relative position and the second function may have a second defined correlation with a variation of the second metamaterial characteristic relative to the relative position. Therefore, the receiver circuit may be configured to generate the first measurement based on the first function and generate the second measurement based on the second function. In particular, the receiver circuit may be configured to use a first wave measurement (e.g., an amplitude measurement or a frequency measurement used as the first measured value) of the electromagnetic receive wave and a second wave measurement (e.g., an amplitude measurement or a frequency measurement used as the second measured value) of the electromagnetic receive wave as first input variables for the first function to generate the first measurement. Additionally, the receiver circuit may be configured to use the first wave measurement of the electromagnetic receive wave and the second wave measurement of the electromagnetic receive wave as second input variables for the second function to generate the second measurement. Since the second function is different from the first function, the first function and the second function generate different results (e.g., a unique measurement set) that correspond to the relative position. Therefore, the receiver circuit may be configured to determine the relative position based on the first measurement and the second measurement.

In some implementations, the first function may include M2/M1, where M1 denotes the first measured value and M2 denotes the second measured value. In some implementations, the first function may be an arctangent of M2/M1. Alternatively, the first function may include (M1−M2)/(M1+M2). In addition, the second function may include M1²+M2². An output of the first function corresponds to the first measurement and an output of the second function corresponds to the second measurement. A combination of the first measurement and the second measurement, obtained as a measurement set, may be unique to the relative position of the 2D metamaterial array 200 relative to the transceiver 308. Thus, the receiver circuit may use a look-up table (LUT) or some other functional relationship to determine the relative position of the 2D metamaterial array 200, relative to the transceiver 308, based on the first measurement and the second measurement. The first function and the second function, described above, are merely examples. It will be appreciated that other functions may be used that have the first defined correlation and the second defined correlation described above.

In some implementations, the receiver circuit may be configured to measure a phase shift of the electromagnetic receive wave, for example, relative to the electromagnetic transmit wave, and determine a distance to the 2D metamaterial array 200 based on the phase shift.

Alternatively, in some implementations, the transmitter antenna 310 and the transmitter antenna 312 may be configured to transmit respective electromagnetic transmit waves in parallel (e.g., simultaneously) at the 2D metamaterial array 200 to perform a position measurement. For example, the transmitter antenna 310 may be configured to transmit the first electromagnetic transmit wave having a wave property set to a first value and the transmitter antenna 312 may be configured to transmit a second electromagnetic transmit wave having the wave property set to a second value that is different from the first value of the wave property. In some implementations, the wave property set to the first value is a first polarization (e.g., a first linear polarization) and the wave property set to the second value is a second polarization (e.g., a second linear polarization). For example, in some implementations, the first polarization may be perpendicular to the second polarization. Alternatively, in some implementations, the wave property set to the first value is a first frequency or a first frequency range and the wave property set to the second value is a second frequency or a second frequency range.

As a result, the 2D metamaterial array 200 may be configured to convert the first electromagnetic transmit wave into a first electromagnetic receive wave based on the relative position of the 2D metamaterial array 200 and convert the second electromagnetic transmit wave into a second electromagnetic receive wave based on the relative position of the 2D metamaterial array 200. For example, the first electromagnetic receive wave and the second electromagnetic receive wave may have different amplitudes or different frequencies based on the relative position of the 2D metamaterial array 200 that corresponds to a point of incidence of the first and the second electromagnetic transmit waves on the 2D metamaterial array 200.

The receiver antenna 314 may be configured to receive the first electromagnetic receive wave and the receiver antenna 316 may be configured to receive the second electromagnetic receive wave. Thus, the receiver circuit may be configured to receive the first electromagnetic receive wave and the second electromagnetic receive wave, and determine the relative position based on the first electromagnetic receive wave and the second electromagnetic receive wave.

As noted above in connection with FIG. 2, the elementary structures may have a coordinate-dependent characteristic that varies along the first coordinate variation of the coordinate system and varies along the second coordinate variation of the coordinate system. As a result, the receiver circuit may be configured to generate a first measurement based on the first electromagnetic receive wave and the second electromagnetic receive wave, where the first measurement has a first dependency on the coordinate-dependent characteristic relative to the relative position, and generate a second measurement based on the first electromagnetic receive wave and the second electromagnetic receive wave, where the second measurement has a second dependency on the coordinate-dependent characteristic relative to the relative position. The second dependency is different from the first dependency. As a result, the first measurement is different from the second measurement to form a unique measurement set corresponding to the relative position. Thus, the receiver circuit may be configured to determine the relative position based on the first measurement and the second measurement.

In some implementations, the receiver circuit may be configured to generate a first measured value of the first electromagnetic receive wave, generate a second measured value of the second electromagnetic receive wave, apply the first function using the first measured value and the second measured value to obtain the first measurement, apply the second function using the first measured value and the second measured value to obtain the second measurement, and determine the relative position based on the first measurement and the second measurement. The second function is different from the first function such that the first measurement is different from the second measurement.

The first function may have a first defined correlation with a variation of the first metamaterial characteristic relative to the relative position, and the second function may have a second defined correlation with a variation of the second metamaterial characteristic relative to the relative position. Therefore, the receiver circuit may be configured to generate the first measurement based on the first function and generate the second measurement based on the second function. In particular, the receiver circuit may be configured to use a measurement (e.g., an amplitude measurement or a frequency measurement used as the first measured value) of the first electromagnetic receive wave and a measurement (e.g., an amplitude measurement or a frequency measurement used as the second measured value) of the second electromagnetic receive wave as first input variables for the first function to generate the first measurement. Additionally, the receiver circuit may be configured to use the measurement of the first electromagnetic receive wave and the measurement of the second electromagnetic receive wave as second input variables for the second function to generate the second measurement. Therefore, the receiver circuit may be configured to determine the relative position based on the first measurement and the second measurement.

In some implementations, the first function may include M2/M1, where M1 denotes the first measured value and M2 denotes the second measured value. In some implementations, the first function may be an arctangent of M2/M1. Alternatively, the first function may include (M1−M2)/(M1+M2). In addition, the second function may include M1²+M2². An output of the first function corresponds to the first measurement and an output of the second function corresponds to the second measurement. A combination of the first measurement and the second measurement, obtained as a measurement set, may be unique to the relative position of the 2D metamaterial array 200 relative to the transceiver 308. Thus, the receiver circuit may use a LUT or some other functional relationship to determine the relative position of the 2D metamaterial array 200, relative to the transceiver 308, based on the first measurement and the second measurement. The first function and the second function, described above, are merely examples. It will be appreciated that other functions may be used that have the first defined correlation and the second defined correlation described above.

In some implementations, the receiver circuit may be configured to measure a phase shift of the first electromagnetic receive wave, for example, relative to the first electromagnetic transmit wave, and determine a distance to the 2D metamaterial array 200 based on the phase shift. Alternatively, the receiver circuit may be configured to measure a phase shift of the second electromagnetic receive wave, for example, relative to the second electromagnetic transmit wave, and determine the distance to the 2D metamaterial array 200 based on the phase shift.

Each receiver antenna 314 and 316 is coupled to the receiver circuit of the transceiver 308 that may be configured to demodulate a receive signal (e.g., into baseband) in order to determine a characteristic of the receive signal, such as an amplitude, a frequency, or a phase shift. An absolute angular position of the rotatable target object 302 may be determined by the receiver circuit or a system controller utilizing a signal processor based on one or more determined characteristics, the first function, and the second function.

The receiver circuit may be configured to receive and demodulate a receive signal, and evaluate an amplitude, a frequency, and/or a phase of the receive signal using amplitude analysis, frequency analysis, and/or phase analysis, respectively. The receiver circuit may be configured to determine the relative position based on the measured characteristics of one or more electromagnetic receive waves and based on the first function and the second function. For example, the receiver circuit may refer to the LUT provided in memory that stores angular positions relative to the first measurement resultant from the first function and the second measurement resultant from the second function.

As indicated above, FIG. 3A is provided as an example. Other examples may differ from what is described with regard to FIG. 3A. The number and arrangement of devices and components shown in FIG. 3A are provided as an example. In practice, there may be additional devices or components, fewer devices or components, different devices or components, or differently arranged devices or components than those shown in FIG. 3A. Furthermore, two or more devices or components shown in FIG. 3A may be implemented within a single device or component, or a single device or component shown in FIG. 3A may be implemented as multiple, distributed devices or components. Additionally, or alternatively, a set of devices or components (e.g., one or more devices or components) shown in FIG. 3A may perform one or more functions described as being performed by another set of devices or components shown in FIG. 3A.

For example, it will be appreciated that two transceivers can be used. It will further be appreciated that two receiver and transmitter pairs can be used instead of one or more transceivers. In some implementations, one antenna may be used as a transmit and receive antenna, and a splitter may be used to separate energy transmission paths (e.g., a rat-race coupler or a hybrid ring coupler) in the RF part. The splitter is configured to direct the received wave from the antenna to the receiver while the splitter directs the transmit signal from the transmitter to the antenna for transmission.

Regardless of the configuration, it will be understood that at least one transmitter and at least one receiver are implemented for transmitting and detecting electromagnetic waves. The transmitters and receivers may be electrically coupled to a system controller and/or a digital signal processor (DSP).

FIG. 3B illustrates a position sensor system 300B according to one or more implementations. For example, the position sensor system 300B may be a rotational position sensor system configured to measure a rotational position or a rotation angle. The position sensor system 300B is similar to the position sensor system 300A depicted in FIG. 3A, with the exception that the position sensor system 300B is configured to monitor one or more electromagnetic waves that pass through the 2D metamaterial array 200 instead of monitoring one or more reflected electromagnetic waves, as was the case in FIG. 3A. As a result, the transceiver 308 included in the position sensor system 300A is distributed into a transmitter 308a and a receiver 308b in the position sensor system 300B. The transmitter 308a and the receiver 308b are arranged at opposite sides of the 2D metamaterial array 200 such that the receiver antennas 314 and 316 receive one or more partially-transmitted electromagnetic waves (e.g., electromagnetic receive waves) as a result of one or more electromagnetic transmit waves interacting with (i.e., being partially absorbed by and transmitted through) the 2D metamaterial array 200.

It will also be appreciated that, in some implementations, a combination of the position sensor system 300A and the position sensor system 300B may be realized. For example, one receiver may be arranged for detecting and measuring a partially-reflected electromagnetic receive wave from the 2D metamaterial array 200 and another receiver may be arranged for detecting and measuring a partially-transmitted electromagnetic receive wave that passes through the 2D metamaterial array 200.

Accordingly, each electromagnetic transmit signal may be converted into an electromagnetic receive signal by interacting with the 2D metamaterial array 200. The interaction may include a reflection, an absorption, a transmission, or a combination thereof. Each receiver antenna 314 and 316 is coupled to the receiver circuit of the receiver 308b that may be configured to demodulate a receive signal in order to determine a characteristic of the receive signal, such as an amplitude, a frequency, or a phase shift. An absolute angular position of the rotatable target object 302 may be determined by the receiver circuit or a system controller utilizing a signal processor based on one or more determined characteristics, the first function, and the second function, as described above in connection with FIG. 3A.

The receiver circuit may be configured to receive and demodulate a receive signal, and evaluate an amplitude, a frequency, and/or a phase of the receive signal using amplitude analysis, frequency analysis, and/or phase analysis, respectively. The receiver circuit may be configured to determine the relative position based on the measured characteristics of one or more electromagnetic receive waves and based on the first function and the second function, as described above in connection with FIG. 3A. For example, the receiver circuit may refer to a LUT provided in memory that stores angular positions relative to the first measurement resultant from the first function and the second measurement resultant from the second function.

As indicated above, FIG. 3B is provided as an example. Other examples may differ from what is described with regard to FIG. 3B.

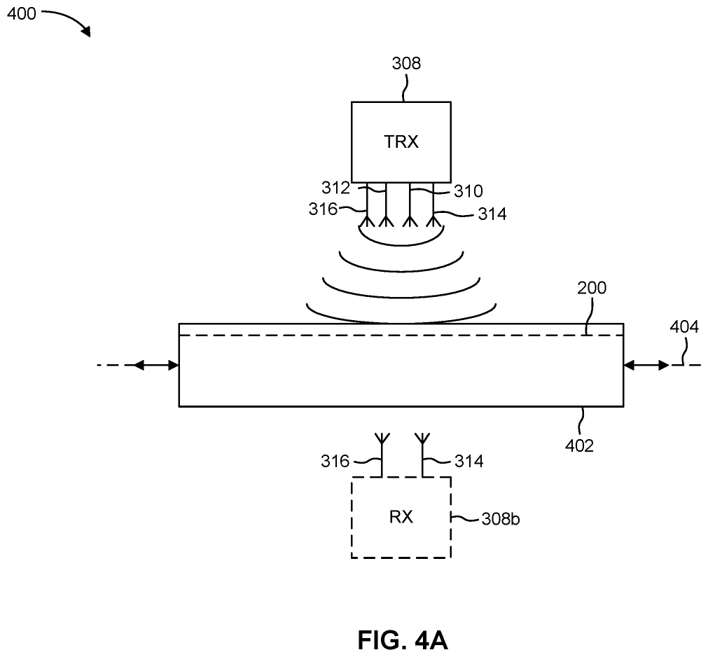

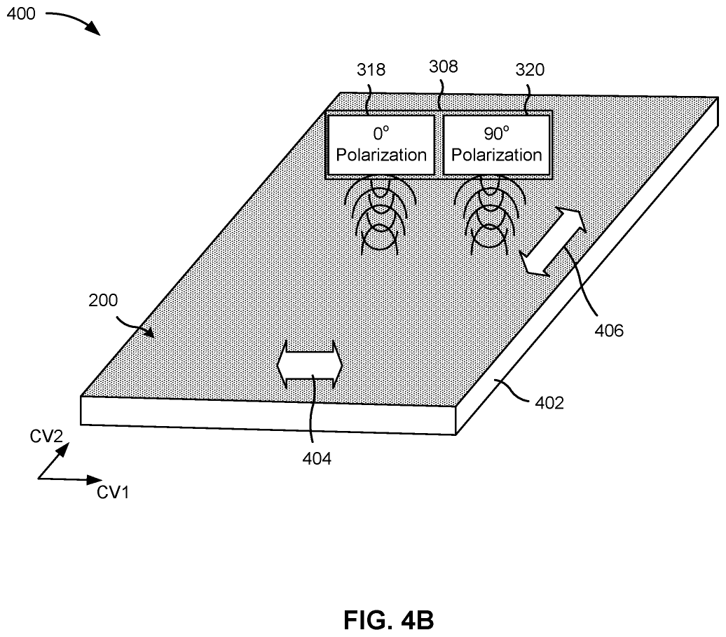

FIG. 4A illustrates a side view and FIG. 4B illustrates a perspective view of a position sensor system 400 according to one or more implementations. For example, the position sensor system 400 may be a linear position sensor system configured to measure a linear position.

The position sensor system 400 may include a linear movable target object 402 configured to move on one or more linear paths 404 and/or 406. For example, the linear path 404 may extend parallel to the first coordinate variation CV1 of a coordinate system and the linear path 406 may extend parallel to the second coordinate variation CV2 of the coordinate system. The linear movable target object 402 may represent a mechanical target for one or more mm-wave beams. The position sensor system 400 may further include the 2D metamaterial array 200 coupled to the linear movable target object 402 as a metamaterial layer. The 2D metamaterial array 200 may extend in two dimensions on a surface of the linear movable target object 402. Alternatively, in some implementations, the 2D metamaterial array 200 may be embedded within the linear movable target object 402. Thus, the coordinate system of the 2D metamaterial array 200 in this example is the Cartesian coordinate system. The 2D metamaterial array 200 may be fixed to the linear movable target object 402 such that the 2D metamaterial array 200 moves with the linear movable target object 402.

The position sensor system 400 may include the transceiver 308 configured to transmit and receive electromagnetic waves (e.g., mm-waves), as similarly described in connection with FIG. 3A. In particular, the transceiver 308 may be configured as a linear position sensor that includes at least one transmitter antenna (e.g., transmitter antennas 310 and 312), at least one receiver antenna (e.g., receiver antennas 314 and 316), a transmitter circuit coupled to the at least one transmitter antenna, and a receiver circuit coupled to the at least one receiver antenna. The receiver circuit may include processing circuitry configured to process received signals for determining a linear position. In some implementations, a separate receiver 308b is provided, as similarly described in connection with FIG. 3B.

The transceiver 308 may be movably fixed and the 2D metamaterial array 200 may be configured to move in one or more linear directions corresponding to the linear paths 404 and/or 406. However, in some implementations, the transceiver 308 may be coupled to the linear movable target object 402 and the 2D metamaterial array 200 may be coupled to a movably fixed structure. In either case, the 2D metamaterial array 200 is configured to have a relative position that is configured to vary relative to the transceiver 308. The position sensor system 400 is configured to measure the relative position, regardless of which configuration is implemented.

Similar principles described above in connection with FIGS. 3A and 3B also apply to the position sensor system 400. Thus, the relative position may be determined by the receiver circuit by obtaining two wave measurements (e.g., the first measured value M1 and the second measured value M2) and using the two wave measurements as input variables for the first function and the second function. A first measurement resultant from the first function and a second measurement resultant from the second function may be used in combination by the receiver circuit to determine the relative position. For example, the receiver circuit may refer to a LUT provided in memory that stores linear positions relative to the first measurement resultant from the first function and the second measurement resultant from the second function.

In FIG. 4B, a first transmitter/receiver pair 318 and a second transmitter/receiver pair 320 of the transceiver 308 are shown. The transmitter of the first transmitter/receiver pair 318 may be configured to transmit the first electromagnetic transmit wave having a wave property set to a first value and the transmitter of the second transmitter/receiver pair 320 may be configured to transmit the second electromagnetic transmit wave having the wave property set to a second value that is different from the first value of the wave property. In some implementations, the wave property set to the first value is a first polarization (e.g., a first linear polarization) and the wave property set to the second value is a second polarization (e.g., a second linear polarization). For example, in some implementations, the first polarization (e.g., a 0° polarization) may be perpendicular to the second polarization (e.g., a 90° polarization). Alternatively, in some implementations, the wave property set to the first value is a first frequency or a first frequency range and the wave property set to the second value is a second frequency or a second frequency range.

The receiver of the first transmitter/receiver pair 318 is configured to receive the first electromagnetic receive wave as a first partially-reflected electromagnetic wave based on the first electromagnetic transmit wave and the relative position of the 2D metamaterial array 200. Similarly, the receiver of the second transmitter/receiver pair 320 is configured to the second electromagnetic receive wave as a second partially-reflected electromagnetic wave based on the second electromagnetic transmit wave and the relative position of the 2D metamaterial array 200.

As indicated above, FIGS. 4A and 4B are provided as examples. Other examples may differ from what is described with regard to FIGS. 4A and 4B.

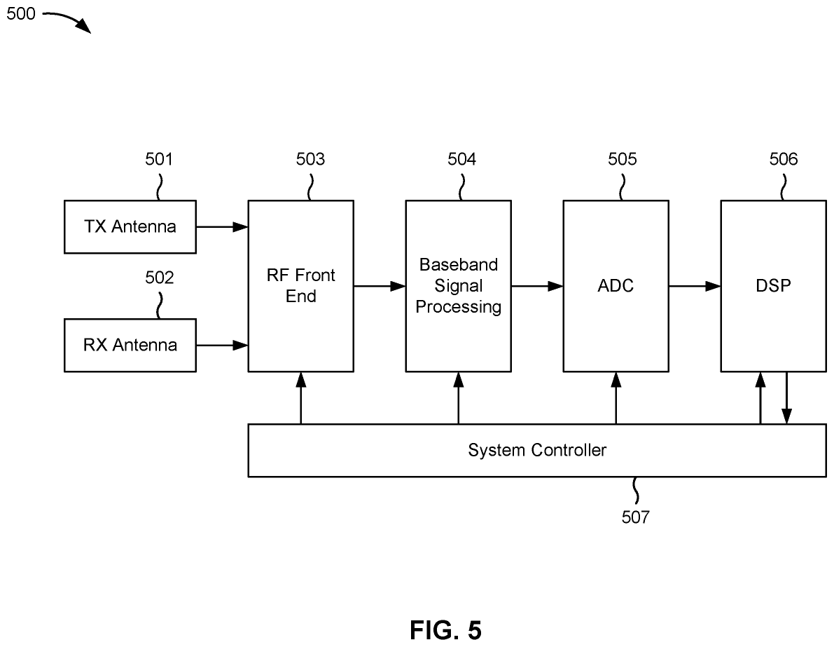

FIG. 5 illustrates an example transceiver circuit of a transceiver 500 according to one or more implementations. The transceiver 500 is representative of any transmitter/receiver combination. The transceiver 500 includes relevant transmitter circuitry and receiver circuitry corresponding to the implementations described herein. It will also be appreciated that the transmission circuitry and the receiver circuitry may be distributed between a transmitter and a receiver that are provided separate from each other.

Frequency modulation may be used on a transmitter side to characterize a transfer function of a transmission channel including the metamaterial over frequency. However, a continuous carrier wave with a constant frequency may also be used.

On the measurement side (e.g., a receiver side), measured properties may be magnitude (amplitude) and phase or in-phase and quadrature components (e.g., I and Q), which may be the most sophisticated and flexible solution. However, with respect to cost, a system with a constant frequency carrier may be preferable. In this case, a frequency may be chosen to be in a defined region with respect to poles and zeros where a phase or amplitude transfer function has a monotonous behavior with respect to the modified property of the metamaterial of the 2D metamaterial array 200. Then, a local measurement of phase shift or amplitude attenuation may be used.

Accordingly, at least one transmission antenna 501 (TX antenna configuration) and a receiver antenna 502 (RX antenna configuration) are connected to an RF front end 503 integrated into a chip. The RF front end may contain circuit components that are used for RF signal processing. These circuit components may comprise, for example, a local oscillator (LO), RF power amplifiers, low noise amplifiers (LNA), directional couplers (e.g., rat-race couplers, circulators), and mixers for downmixing (or down-converting) the RF signals into baseband or an intermediate frequency band (IF band). The RF front end 503 may—possibly together with further circuit components—be integrated into a chip, which is usually referred to as a monolithic microwave integrated circuit (MMIC).

The example illustrated shows a bistatic (or pseudo-monostatic) radar system with separate reception (RX) and transmission (TX) antennas. In the case of a monostatic radar system, a single antenna may be used both to emit and to receive the electromagnetic (radar) signals. In this case, a directional coupler (e.g., a circulator) may be used to separate the RF signals to be emitted from the received RF signals (radar echo signals). Radar systems, in practice, usually have a plurality of transmission and reception channels (TX/RX channels) with a plurality of TX and RX antennas, which makes it possible, inter alia, to measure a direction of arrival (DoA) from which the radar echoes are received. In such multiple-input multiple-output (MIMO) systems, the individual TX channels and RX channels in each case usually have an identical or similar structure.

In the case of a frequency modulated continuous wave (FMCW) radar system, the RF signals emitted by the TX antenna configuration 501 may be, for example, in the range of approximately 10 GHz to 1 THz. However, the frequency bands that are applied here depend on the elementary structures to be used for the generation of the metamaterial target. As mentioned, the RF signal received by the RX antenna configuration 502 comprises the radar echoes (chirp echo signals), that is to say those signal components that are backscattered at one or at a plurality of radar targets. The received RF signal is downmixed, for example, into baseband (or an IF band) and processed further in baseband by way of analog signal processing (see analog baseband signal processing circuitry 504) in order to determine a characteristic of the received RF signal, such as an amplitude, a frequency, or a phase shift.

The analog baseband signal processing circuitry 504 may comprise one or more filters and one or more amplifiers for filtering and amplifying the baseband signal. The baseband signal is digitized by an analog-to-digital converter (ADC) 505 and processed further in the digital domain. The digital signal processing chain may be implemented at least partly in the form of software that is able to be executed on a processor, for example a microcontroller, a DSP 506, or another computer unit.

The overall system is generally controlled by way of a system controller 507 that may likewise be implemented at least partly in the form of software that is able to be executed on a processor, such as, for example, a microcontroller. The RF front end 503 and the analog baseband signal processing circuitry 504 (optionally also the analog-to-digital converter 505) may be integrated together in a single MMIC (that is to say, an RF semiconductor chip). As an alternative, the individual components may also be distributed over a plurality of integrated circuits.

The DSP 506 may be configured to analyze measured values of one or more signals received from the 2D metamaterial array 200 to determine the relative position. The DSP 506 may be configured to perform the aforementioned phase analysis, amplitude analysis, and/or spectral analysis to determine the relative position based on, for example, the determined amplitude modulation and/or phase modulation of received signals. The phase modulation of a received signal may be a phase shift of the received signal with respect to a phase of the transmitted mm-wave. Similarly, the amplitude modulation of a received signal may be an amplitude shift of the received signal with respect to an amplitude of the transmitted mm-wave. The DSP 506 may be configured to determine a phase shift and/or an amplitude shift of a received signal and translate the shift into a relative position. For example, the DSP 506 may refer to a look-up table provided in memory that stores relative positions corresponding to a unique measurement set determined by the first function and the second function.

As indicated above, FIG. 5 is provided as an example. Other examples may differ from what is described with regard to FIG. 5.

The following provides an overview of some Aspects of the present disclosure:
Aspect 1: A sensor system, comprising: at least one transmitter; a receiver circuit; and a metamaterial layer having a relative position that is configured to vary relative to at least one of the at least one transmitter or the receiver circuit, wherein the metamaterial layer comprises an array of elementary structures arranged within a coordinate system of the metamaterial layer, wherein the array of elementary structures comprises a first metamaterial characteristic that changes along a first coordinate variation of the coordinate system and a second metamaterial characteristic that changes along a second coordinate variation of the coordinate system, and wherein the first metamaterial characteristic is different from the second metamaterial characteristic, wherein the at least one transmitter is configured to transmit a first electromagnetic transmit wave toward the metamaterial layer, wherein the metamaterial layer is configured to convert the first electromagnetic transmit wave into a first electromagnetic receive wave based on the relative position, and wherein the receiver circuit is configured to receive the first electromagnetic receive wave and determine the relative position based on the first electromagnetic receive wave.
Aspect 2: The sensor system of Aspect 1, wherein the receiver circuit is configured to generate a first measured value of the first electromagnetic receive wave, generate a second measured value of the first electromagnetic receive wave, apply a first function using the first measured value and the second measured value to obtain a first measurement, apply a second function using the first measured value and the second measured value to obtain a second measurement, and determine the relative position based on the first measurement and the second measurement, wherein the second function is different from the first function.
Aspect 3: The sensor system of any of Aspects 1-2, wherein the at least one transmitter is configured to transmit the first electromagnetic transmit wave, having a wave property set to a first value, toward the metamaterial layer and transmit a second electromagnetic transmit wave, having the wave property set to a second value, toward the metamaterial layer, wherein the first value of the wave property is different from the second value of the wave property, wherein the metamaterial layer is configured to convert the first electromagnetic transmit wave into the first electromagnetic receive wave based on the relative position, wherein the metamaterial layer is configured to convert the second electromagnetic transmit wave into a second electromagnetic receive wave based on the relative position, and wherein the receiver circuit is configured to receive the first electromagnetic receive wave and the second electromagnetic receive wave, and determine the relative position based on the first electromagnetic receive wave and the second electromagnetic receive wave.
Aspect 4: The sensor system of Aspect 3, wherein the wave property set to the first value is a first polarization and the wave property set to the second value is a second polarization, or wherein the wave property set to the first value is a first frequency range and the wave property set to the second value is a second frequency range.
Aspect 5: The sensor system of Aspect 3, wherein the receiver circuit is configured to generate a first measured value of the first electromagnetic receive wave, generate a second measured value of the second electromagnetic receive wave, apply a first function using the first measured value and the second measured value to obtain a first measurement, apply a second function using the first measured value and the second measured value to obtain a second measurement, and determine the relative position based on the first measurement and the second measurement, wherein the second function is different from the first function.
Aspect 6: The sensor system of Aspect 5, wherein the first measured value is at least one of an amplitude or a frequency of the first electromagnetic receive wave.
Aspect 7: The sensor system of Aspect 5, wherein the second function includes M12+M22, wherein M1 denotes the first measured value and M2 denotes the second measured value, wherein the first function includes M2/M1, wherein M1 denotes the first measured value and M2 denotes the second measured value, or wherein the first function includes (M1−M2)/(M1+M2), wherein M1 denotes the first measured value and M2 denotes the second measured value.
Aspect 8: The sensor system of Aspect 3, wherein the receiver circuit is configured to generate a first measurement based on a first function that has a first defined correlation with a variation of the first metamaterial characteristic relative to the relative position, wherein the receiver circuit is configured to use a measurement of the first electromagnetic receive wave and a measurement of the second electromagnetic receive wave as first input variables for the first function to generate the first measurement, wherein the receiver circuit is configured to generate a second measurement based on a second function that has a second defined correlation with a variation of the second metamaterial characteristic relative to the relative position, wherein the receiver circuit is configured to use the measurement of the first electromagnetic receive wave and the measurement of the second electromagnetic receive wave as second input variables for the second function to generate the second measurement, and wherein the receiver circuit is configured to determine the relative position based on the first measurement and the second measurement.
Aspect 9: The sensor system of Aspect 3, wherein the receiver circuit is configured to generate a first measurement based on the first electromagnetic receive wave and the second electromagnetic receive wave, wherein the first measurement has a first dependency on the first metamaterial characteristic relative to the relative position, wherein the receiver circuit is configured to generate a second measurement based on the first electromagnetic receive wave and the second electromagnetic receive wave, wherein the second measurement has a second dependency on the second metamaterial characteristic relative to the relative position, and wherein the receiver circuit is configured to determine the relative position based on the first measurement and the second measurement.
Aspect 10: The sensor system of any of Aspects 1-9, wherein the receiver circuit is configured to generate a first measurement based on a first function that has a first defined correlation with a variation of the first metamaterial characteristic relative to the relative position, wherein the receiver circuit is configured to use a first wave measurement and a second wave measurement of the first electromagnetic receive wave as first input variables for the first function to generate the first measurement, wherein the receiver circuit is configured to generate a second measurement based on a second function that has a second defined correlation with a variation of the second metamaterial characteristic relative to the relative position, wherein the receiver circuit is configured to use the first wave measurement and the second wave measurement as second input variables for the second function to generate the second measurement, and wherein the receiver circuit is configured to determine the relative position based on the first measurement and the second measurement.
Aspect 11: The sensor system of any of Aspects 1-10, wherein the receiver circuit is configured to generate a first measurement based on the first electromagnetic receive wave, wherein the first measurement has a first dependency on the first metamaterial characteristic relative to the relative position, wherein the receiver circuit is configured to generate a second measurement based on the first electromagnetic receive wave, wherein the second measurement has a second dependency on the second metamaterial characteristic relative to the relative position, and wherein the receiver circuit is configured to determine the relative position based on the first measurement and the second measurement.
Aspect 12: The sensor system of any of Aspects 1-11, wherein the elementary structures have coordinate-dependent characteristic that varies along the first coordinate variation of the coordinate system and varies along the second coordinate variation of the coordinate system.
Aspect 13: The sensor system of Aspect 12, wherein the coordinate-dependent characteristic is a coordinate-dependent coupling that varies along the first coordinate variation of the coordinate system and varies along the second coordinate variation of the coordinate system, and wherein each coordinate of the metamaterial layer has a unique coordinate-dependent coupling.
Aspect 14: The sensor system of Aspect 3, wherein the elementary structures have coordinate-dependent characteristic that varies along the first coordinate variation of the coordinate system and varies along the second coordinate variation of the coordinate system, wherein the receiver circuit is configured to generate a first measurement based on the first electromagnetic receive wave and the second electromagnetic receive wave, wherein the first measurement has a first dependency on the coordinate-dependent characteristic relative to the relative position, wherein the receiver circuit is configured to generate a second measurement based on the first electromagnetic receive wave and the second electromagnetic receive wave, wherein the second measurement has a second dependency on the coordinate-dependent characteristic relative to the relative position, wherein the second dependency is different from the first dependency, and wherein the receiver circuit is configured to determine the relative position based on the first measurement and the second measurement.
Aspect 15: The sensor system of any of Aspects 1-14, wherein the first metamaterial characteristic affects a first millimeter-wave (mm-wave) property of the metamaterial layer and the second metamaterial characteristic affects a second mm-wave property of the metamaterial layer, and wherein the first mm-wave property is different from the second mm-wave property.
Aspect 16: The sensor system of any of Aspects 1-15, wherein the first metamaterial characteristic is a radial orientation of the elementary structures that changes incrementally along the first coordinate variation, or wherein the first metamaterial characteristic is a polarization sensitivity of the elementary structures that rotates incrementally along the first coordinate variation.
Aspect 17: The sensor system of any of Aspects 1-16, wherein the second metamaterial characteristic is a size of the elementary structures that changes incrementally along the second coordinate variation, or wherein the second metamaterial characteristic is a geometry of the elementary structures that is scaled incrementally along the second coordinate variation.
Aspect 18: The sensor system of any of Aspects 1-17, wherein the coordinate system is a polar coordinate system, the first coordinate variation is a radial dimension of the polar coordinate system, and the second coordinate variation is an angular dimension of the polar coordinate system.
Aspect 19: The sensor system of any of Aspects 1-18, wherein the coordinate system is a Cartesian coordinate system, the first coordinate variation is a first axial direction, and the second coordinate variation is a second axial direction that is different to the first axial direction.
Aspect 20: The sensor system of any of Aspects 1-19, wherein the receiver circuit is configured to measure a phase shift of the first electromagnetic receive wave, and determine a distance to the metamaterial layer based on the phase shift.
Aspect 21: A system configured to perform one or more operations recited in one or more of Aspects 1-20.
Aspect 22: An apparatus comprising means for performing one or more operations recited in one or more of Aspects 1-20.
Aspect 23: A non-transitory computer-readable medium storing a set of instructions, the set of instructions comprising one or more instructions that, when executed by a device, cause the device to perform one or more operations recited in one or more of Aspects 1-20.
Aspect 24: A computer program product comprising instructions or code for executing one or more operations recited in one or more of Aspects 1-20.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software. It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Any of the processing components may be implemented as a central processing unit (CPU) or other processor reading and executing a software program from a non-transitory computer-readable recording medium such as a hard disk or a semiconductor memory device. For example, instructions may be executed by one or more processors, such as one or more CPUs, DSPs, general-purpose microprocessors, application-specific integrated circuits (ASICs), field programmable logic arrays (FPLAs), programmable logic controller (PLC), or other equivalent integrated or discrete logic circuitry. Accordingly, the term “processor,” as used herein refers to any of the foregoing structures or any other structure suitable for implementation of the techniques described herein. Software may be stored on a non-transitory computer-readable medium such that the non-transitory computer readable medium includes a program code or a program algorithm stored thereon which, when executed, causes the processor, via a computer program, to perform the steps of a method.

A controller including hardware may also perform one or more of the techniques of this disclosure. A controller, including one or more processors, may use electrical signals and digital algorithms to perform its receptive, analytic, and control functions, which may further include corrective functions. Such hardware, software, and firmware may be implemented within the same device or within separate devices to support the various techniques described in this disclosure.

A signal processing circuit and/or a signal conditioning circuit may receive one or more signals (e.g., measurement signals) from one or more components in the form of raw measurement data and may derive, from the measurement signal further information. Signal conditioning, as used herein, refers to manipulating an analog signal in such a way that the signal meets the requirements of a next stage for further processing. Signal conditioning may include converting from analog to digital (e.g., via an analog-to-digital converter), amplification, filtering, converting, biasing, range matching, isolation and any other processes required to make a signal suitable for processing after conditioning.

Some implementations may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

Further, it is to be understood that the disclosure of multiple acts or functions disclosed in the specification or in the claims may not be construed as to be within the specific order. Therefore, the disclosure of multiple acts or functions will not limit these to a particular order unless such acts or functions are not interchangeable for technical reasons. Furthermore, in some implementations, a single act may include or may be broken into multiple sub acts. Such sub acts may be included and part of the disclosure of this single act unless explicitly excluded.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A sensor system, comprising:
at least one transmitter;
a receiver circuit; and
a metamaterial layer having a relative position that is configured to vary relative to at least one of the at least one transmitter or the receiver circuit, wherein the metamaterial layer comprises an array of elementary structures arranged within a coordinate system of the metamaterial layer, wherein the array of elementary structures comprises a first metamaterial characteristic that changes along a first coordinate variation of the coordinate system and a second metamaterial characteristic that changes along a second coordinate variation of the coordinate system, and wherein the first metamaterial characteristic is different from the second metamaterial characteristic,
wherein the at least one transmitter is configured to transmit a first electromagnetic transmit wave toward the metamaterial layer,
wherein the metamaterial layer is configured to convert the first electromagnetic transmit wave into a first electromagnetic receive wave based on the relative position, and
wherein the receiver circuit is configured to receive the first electromagnetic receive wave and determine the relative position based on the first electromagnetic receive wave.

2. The sensor system of claim 1, wherein the receiver circuit is configured to generate a first measured value of the first electromagnetic receive wave, generate a second measured value of the first electromagnetic receive wave, apply a first function using the first measured value and the second measured value to obtain a first measurement, apply a second function using the first measured value and the second measured value to obtain a second measurement, and determine the relative position based on the first measurement and the second measurement,
wherein the second function is different from the first function.

3. The sensor system of claim 1, wherein the at least one transmitter is configured to transmit the first electromagnetic transmit wave, having a wave property set to a first value, toward the metamaterial layer and transmit a second electromagnetic transmit wave, having the wave property set to a second value, toward the metamaterial layer, wherein the first value of the wave property is different from the second value of the wave property,
wherein the metamaterial layer is configured to convert the first electromagnetic transmit wave into the first electromagnetic receive wave based on the relative position,
wherein the metamaterial layer is configured to convert the second electromagnetic transmit wave into a second electromagnetic receive wave based on the relative position, and
wherein the receiver circuit is configured to receive the first electromagnetic receive wave and the second electromagnetic receive wave, and determine the relative position based on the first electromagnetic receive wave and the second electromagnetic receive wave.

4. The sensor system of claim 3, wherein the wave property set to the first value is a first polarization and the wave property set to the second value is a second polarization, or
wherein the wave property set to the first value is a first frequency range and the wave property set to the second value is a second frequency range.

5. The sensor system of claim 3, wherein the receiver circuit is configured to generate a first measured value of the first electromagnetic receive wave, generate a second measured value of the second electromagnetic receive wave, apply a first function using the first measured value and the second measured value to obtain a first measurement, apply a second function using the first measured value and the second measured value to obtain a second measurement, and determine the relative position based on the first measurement and the second measurement,
wherein the second function is different from the first function.

6. The sensor system of claim 5, wherein the first measured value is at least one of an amplitude or a frequency of the first electromagnetic receive wave.

7. The sensor system of claim 5, wherein the second function includes M1²+M2², wherein M1 denotes the first measured value and M2 denotes the second measured value,
wherein the first function includes M2/M1, wherein M1 denotes the first measured value and M2 denotes the second measured value, or
wherein the first function includes (M1−M2)/(M1+M2), wherein M1 denotes the first measured value and M2 denotes the second measured value.

8. The sensor system of claim 3, wherein the receiver circuit is configured to generate a first measurement based on a first function that has a first defined correlation with a variation of the first metamaterial characteristic relative to the relative position,
wherein the receiver circuit is configured to use a measurement of the first electromagnetic receive wave and a measurement of the second electromagnetic receive wave as first input variables for the first function to generate the first measurement,
wherein the receiver circuit is configured to generate a second measurement based on a second function that has a second defined correlation with a variation of the second metamaterial characteristic relative to the relative position,
wherein the receiver circuit is configured to use the measurement of the first electromagnetic receive wave and the measurement of the second electromagnetic receive wave as second input variables for the second function to generate the second measurement, and
wherein the receiver circuit is configured to determine the relative position based on the first measurement and the second measurement.

9. The sensor system of claim 3, wherein the receiver circuit is configured to generate a first measurement based on the first electromagnetic receive wave and the second electromagnetic receive wave,
wherein the first measurement has a first dependency on the first metamaterial characteristic relative to the relative position,
wherein the receiver circuit is configured to generate a second measurement based on the first electromagnetic receive wave and the second electromagnetic receive wave,
wherein the second measurement has a second dependency on the second metamaterial characteristic relative to the relative position, and
wherein the receiver circuit is configured to determine the relative position based on the first measurement and the second measurement.

10. The sensor system of claim 1, wherein the receiver circuit is configured to generate a first measurement based on a first function that has a first defined correlation with a variation of the first metamaterial characteristic relative to the relative position,
wherein the receiver circuit is configured to use a first wave measurement and a second wave measurement of the first electromagnetic receive wave as first input variables for the first function to generate the first measurement,
wherein the receiver circuit is configured to generate a second measurement based on a second function that has a second defined correlation with a variation of the second metamaterial characteristic relative to the relative position,
wherein the receiver circuit is configured to use the first wave measurement and the second wave measurement as second input variables for the second function to generate the second measurement, and
wherein the receiver circuit is configured to determine the relative position based on the first measurement and the second measurement.

11. The sensor system of claim 1, wherein the receiver circuit is configured to generate a first measurement based on the first electromagnetic receive wave,
wherein the first measurement has a first dependency on the first metamaterial characteristic relative to the relative position,
wherein the receiver circuit is configured to generate a second measurement based on the first electromagnetic receive wave,
wherein the second measurement has a second dependency on the second metamaterial characteristic relative to the relative position, and
wherein the receiver circuit is configured to determine the relative position based on the first measurement and the second measurement.

12. The sensor system of claim 1, wherein the elementary structures have coordinate-dependent characteristic that varies along the first coordinate variation of the coordinate system and varies along the second coordinate variation of the coordinate system.

13. The sensor system of claim 12, wherein the coordinate-dependent characteristic is a coordinate-dependent coupling that varies along the first coordinate variation of the coordinate system and varies along the second coordinate variation of the coordinate system, and
wherein each coordinate of the metamaterial layer has a unique coordinate-dependent coupling.

14. The sensor system of claim 3, wherein the elementary structures have coordinate-dependent characteristic that varies along the first coordinate variation of the coordinate system and varies along the second coordinate variation of the coordinate system,
wherein the receiver circuit is configured to generate a first measurement based on the first electromagnetic receive wave and the second electromagnetic receive wave,
wherein the first measurement has a first dependency on the coordinate-dependent characteristic relative to the relative position,
wherein the receiver circuit is configured to generate a second measurement based on the first electromagnetic receive wave and the second electromagnetic receive wave,
wherein the second measurement has a second dependency on the coordinate-dependent characteristic relative to the relative position,
wherein the second dependency is different from the first dependency, and
wherein the receiver circuit is configured to determine the relative position based on the first measurement and the second measurement.

15. The sensor system of claim 1, wherein the first metamaterial characteristic affects a first millimeter-wave (mm-wave) property of the metamaterial layer and the second metamaterial characteristic affects a second mm-wave property of the metamaterial layer, and
wherein the first mm-wave property is different from the second mm-wave property.

16. The sensor system of claim 1, wherein the first metamaterial characteristic is a radial orientation of the elementary structures that changes incrementally along the first coordinate variation, or wherein the first metamaterial characteristic is a polarization sensitivity of the elementary structures that rotates incrementally along the first coordinate variation.

17. The sensor system of claim 1, wherein the second metamaterial characteristic is a size of the elementary structures that changes incrementally along the second coordinate variation, or
wherein the second metamaterial characteristic is a geometry of the elementary structures that is scaled incrementally along the second coordinate variation.

18. The sensor system of claim 1, wherein the coordinate system is a polar coordinate system, the first coordinate variation is a radial dimension of the polar coordinate system, and the second coordinate variation is an angular dimension of the polar coordinate system.

19. The sensor system of claim 1, wherein the coordinate system is a Cartesian coordinate system, the first coordinate variation is a first axial direction, and the second coordinate variation is a second axial direction that is different to the first axial direction.

20. The sensor system of claim 1, wherein the receiver circuit is configured to measure a phase shift of the first electromagnetic receive wave, and determine a distance to the metamaterial layer based on the phase shift.
